(19) United States
(12) Patent Application Publication
(10) Pub. No.: US 2026/0135095 A1
(43) Pub. Date: May 14, 2026

(54) CATHODE ACTIVE MATERIAL FOR CHLORIDE-ION BATTERY AND PRODUCTION METHOD OF SAME, CATHODE COMPOSITE MATERIAL FOR CHLORIDE-ION BATTERY, AND CHLORIDE-ION BATTERY

(71) Applicant: TOYOTA JIDOSHA KABUSHIKI KAISHA, Toyota-shi (JP)

(72) Inventor: Hidenori MIKI, Hiratsuka-shi (JP)

(73) Assignee: TOYOTA JIDOSHA KABUSHIKI KAISHA, Toyota-shi (JP)

(21) Appl. No.: 19/280,585

(22) Filed: Jul. 25, 2025

(30) Foreign Application Priority Data
Nov. 11, 2024 (JP) 2024-196902

(51) Int. Cl. H01M 4/48; H01M 4/04; H01M 10/054

(52) U.S. Cl. CPC H01M 4/483; H01M 4/0471; H01M 10/054

(57) ABSTRACT

A cathode active material for a chloride-ion battery according to the present disclosure is a strontium ruthenium oxide having a layered perovskite structure. A method for producing a cathode active material according to the present disclosure includes (a) preparing a raw material mixture by mixing strontium carbonate and ruthenium oxide, (b) pelletizing the raw material mixture into pellets, and (c) firing the pellets. A cathode composite material for a chloride-ion battery according to the present disclosure includes the cathode active material according to the present disclosure. The chloride-ion battery according to the present disclosure includes a cathode active material layer, and also the cathode active material layer contains the cathode composite material according to the present disclosure.

### CROSS-REFERENCE TO RELATED APPLICATION

This application claims priority to Japanese Patent Application No. 2024-196902 filed on Nov. 11, 2024. The disclosure of the above-identified application, including the specification, drawings, and claims, is incorporated by reference herein in its entirety.

### BACKGROUND

### 1. Technical Field

The present disclosure relates to a cathode active material for a chloride-ion battery and a production method of the same, a cathode composite material for the chloride-ion battery, and the chloride-ion battery.

### 2. Description of Related Art

Metal chlorides are known as cathode active materials for chloride-ion batteries, such as disclosed in Xiangyu Zhao et al., “Chloride-ion battery: a new member in the rechargeable battery family”, Journal of Power Sources 245 (2014) 706-711, Ryo Sakamoto et al., “Room-temperature operation of all-solid-state chloride-ion battery with perovskite-type CsSn_{0.95}Mn_{0.05}Cl₃ as a solid electrolyte”, Electrochemistry, 91 (7), 077003 (2023), and Japanese Unexamined Patent Application Publication No. 2022-126132 (JP 2022-126132 A).

### SUMMARY

An object of the present disclosure is to provide a novel cathode active material for a chloride-ion battery and a production method of the same, a cathode composite material for a chloride-ion battery including such a cathode active material, and a chloride-ion battery containing such a cathode composite material.

The present inventors have found that the above problems can be solved by the following measures.

### Aspect 1

A cathode active material for a chloride-ion battery, in which the cathode active material is a strontium ruthenium oxide with a layered perovskite structure.

### Aspect 2

The cathode active material according to Aspect 1, in which the strontium ruthenium oxide is Sr₃Ru₂Oₓ (5≤x≤7).

### Aspect 3

A cathode composite material for a chloride-ion battery, the cathode composite material including the cathode active material according to Aspect 1 or 2.

### Aspect 4

A chloride-ion battery including a cathode active material layer, in which the cathode active material layer contains the cathode composite material according to Aspect 3.

### Aspect 5

A production method for producing the cathode active material according to Aspect 1 or 2, the production method including
(a) preparing a raw material mixture by mixing strontium carbonate and ruthenium oxide,
(b) pelletizing the raw material mixture into pellets, and
(c) firing the pellets.

According to the present disclosure, a novel cathode active material for a chloride-ion battery and a production method of the same, a cathode composite material for a chloride-ion battery including such a cathode active material, and a chloride-ion battery containing such a cathode composite material, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of an example of a chloride-ion battery according to the present disclosure;

FIG. 2A is an X-ray diffraction (XRD) pattern of a battery according to an Example;

FIG. 2B is an enlarged view of a region from 8° to 38° in the XRD pattern in FIG. 2A;

FIG. 3 is charging/discharging curves of the battery according to the Example;

FIG. 4 is charging/discharging curves of a battery according to a Comparative Example; and

FIG. 5 is a graph showing cycle characteristics of the battery according to the Comparative Example, i.e., a relation between count of charging/discharging cycles and capacity.

### DETAILED DESCRIPTION OF EMBODIMENTS

An embodiment of the present disclosure will be described below in detail. Note that the present disclosure is not limited to the following embodiment, and can be carried out modified in various ways within the scope of the present disclosure.

### Cathode Active Material for Chloride-Ion Battery

A cathode active material for a chloride-ion battery according to the present disclosure is a strontium ruthenium oxide having a layered perovskite structure.

The present disclosers unexpectedly found that strontium ruthenium oxide having a layered perovskite structure functions as a cathode active material for a chloride-ion battery.

The present disclosers also found that such a cathode active material for a chloride-ion battery can improve cycle characteristics of the battery.

The present disclosers reasoned that cycle characteristics of a battery including a conventional cathode active material for a chloride-ion battery, which is a metal chloride, is poor for the following reasons, for example.
The cathode active material, which is a metal chloride, is easily dissolved in electrolytic solutions.
Charging/discharging of batteries containing cathode active materials that are metal chlorides is performed through a conversion reaction, resulting in great expansion and contraction during charging and discharging, which tends to reduce contact between cathode active material and electrolyte during charging/discharging cycles.

In contrast, the reason that a cathode active material for a chloride-ion battery, which is strontium ruthenium oxide having a layered perovskite structure, can improve the cycle characteristics of the battery is presumed to be as follows, without intending to be bound by any theory. That is to say, a battery including the cathode active material for a chloride-ion battery according to the present disclosure is charged and discharged by an intercalation reaction (insertion reaction), and therefore is thought to have small expansion and contraction due to charging/discharging. This is thought to enable suppressing the decrease in contact between the cathode active material and the electrolyte during charging/discharging cycles, thereby improving the cycle characteristics of the battery.

The strontium ruthenium oxide may be Sr₃Ru₂Oₓ (5≤x≤7). Strontium ruthenium oxide having a layered perovskite structure is usually expressed as Sr₃Ru₂O₇. In contrast, strontium ruthenium oxide being expressed as Sr₃Ru₂Oₓ (5≤x≤7) means that the strontium ruthenium oxide has an oxygen-deficient layered perovskite structure. In this composition formula, x may be 5.5 or more, 6.0 or more, 6.3 or more, 6.5 or more, 6.6 or more, 6.7 or more, 6.8 or more, or 6.9 or more, and may be 7.0 or less, 6.9 or less, 6.8 or less, 6.7 or less, 6.6 or less, or 6.5 or less. Here, x may be 6.5 or more and 7 or less. Also, x may be 7, i.e., the strontium ruthenium oxide may be Sr₃Ru₂O₇.

The strontium ruthenium oxide may have a Ruddlesden-Popper type layered perovskite structure.

The shape, size, etc. of the cathode active material for a chloride-ion battery according to the present disclosure are not particularly limited as long as it can function as a cathode active material for a chloride-ion battery.

The cathode active material for a chloride-ion battery according to the present disclosure may be produced by the production method described below, or may be produced by another method.

### Production Method of Cathode Active Material for Chloride-Ion Battery

A method according to the present disclosure for producing the cathode active material for a chloride-ion battery includes the steps of:
(a) mixing strontium carbonate and ruthenium oxide to prepare a raw material mixture (raw material mixing step),
(b) pelletizing the raw material mixture to form pellets (pellet forming step), and
(c) firing the pellets (firing step).

That is to say, the cathode active material for a chloride-ion battery according to the present disclosure, which is strontium ruthenium oxide having a layered perovskite structure, can be produced by solid-phase synthesis.

### Mixing Step

The method according to the present disclosure includes (a) mixing strontium carbonate and ruthenium oxide to prepare a raw material mixture.

The molar ratio of the mixed strontium carbonate and ruthenium oxide may be 3:2.

The method for mixing the strontium carbonate and the ruthenium oxide is not limited in particular, and examples thereof may include a method of mixing in a mortar. Mixing conditions, such as mixing time and so forth, are not limited in particular.

### Pellet Forming Step

The method according to the present disclosure includes (b) pelletizing the raw material mixture to form pellets.

The method for pelletizing the raw material mixture is not limited in particular, and an ordinary method in solid-phase synthesis can be used.

### Firing Step

The method according to the present disclosure includes (c) firing the pellets.

The firing conditions, such as firing temperature, firing time, and so forth, are not limited in particular. The firing temperature may be, for example, 500° C. or higher, 750° C. or higher, 1000° C. or higher, 1100° C. or higher, 1200° C. or higher, or 1300° C. or higher, and may be 2000° C. or lower, 1750° C. or lower, 1500° C. or lower, or 1400° C. or lower, or may be 1350° C. The firing time may be, for example, 1 hour or more, 5 hours or more, 10 hours or more, 15 hours or more, or 20 hours or more, and may be 50 hours or less, 40 hours or less, 30 hours or less, 25 hours or less, or 20 hours or less, or may be 20 hours.

The device that is used in the firing step is not limited in particular, and may be an electric furnace, for example.

The method according to the present disclosure may further include the steps of:
(d) crushing the fired pellets to obtain crushed material (crushing step),
(e) mixing the crushed material to prepare a crushed material mixture (crushed material mixing step),
(f) pelletizing the crushed material mixture to form pellets (pellet forming step), and
(g) firing the pellets (pellet firing step).

Note that when the method according to the present disclosure further includes the steps (d) to (g), the steps (a) to (f) can be expressed as the following steps (a′) to (f*):
(a′) mixing strontium carbonate and ruthenium oxide to prepare a raw material mixture (raw material mixing step),
(b′) pelletizing the raw material mixture to form first pellets (first pellet forming step),
(c′) firing the first pellets (first firing step),
(d′) crushing the first pellets that are fired to obtain crushed material (crushing step),
(e′) mixing the crushed material to obtain a crushed material mixture (crushed material mixing step),
(f′) pelletizing the crushed material mixture to form second pellets (second pellet forming step), and
(g′) firing the second pellets (second firing step).

For steps (a′) to (c′), the above description regarding steps (a) to (c) can be referenced.

### Crushing Step

The method according to the present disclosure may include crushing the first pellets that are fired to obtain a crushed material.

The method for crushing the first pellets that are fired is not limited in particular, and any ordinary method can be employed.

### Crushed Material Mixing Step

The method according to the present disclosure may include mixing the crushed material to obtain a crushed material mixture.

The method for mixing the crushed material is not limited in particular, and may be, for example, the same method as that used in the raw material mixing step, or may be a different method.

### Second Pellet Forming Step

The method according to the present disclosure may include pelletizing the crushed material mixture to form the second pellets.

The method for pelletizing the mixture that is obtained by mixing the crushed material is not limited in particular, and an ordinary method in solid-phase synthesis can be used.

### Second Firing Step

The method of the present disclosure may include firing the second pellets.

The firing conditions of the second firing step, and the device that is used for the firing, are not limited in particular, and may be the same as those in the first firing step, or may be different, for example, but may be the same in particular.

Steps (d) to (g) ((d′) to (g′)) may be repeated until the cathode active material for a chloride-ion battery according to the present disclosure is sufficiently prepared. In this case, the above “first” in steps (d′) to (g′) can be read as “n'th”, and the above “second” can be read as “n′th+1”. This “n” is not limited in particular, and may be, for example, 1 or more, 4 or less, 3 or less, or 2 or less, or may be 1.

### Cathode Composite Material for Chloride-Ion Battery

The cathode composite material for a chloride-ion battery according to the present disclosure includes a cathode active material, and may optionally include a solid electrolyte, a conductive aid, and so forth.

With respect to the present disclosure, “cathode composite material” means a composition that can make up a cathode active material layer, either as it is or by further containing other components. Also, with respect to the present disclosure, “cathode composite material slurry” refers to a slurry that contains a dispersion medium in addition to “cathode composite material” and that can be applied and dried to form a cathode active material layer.

Hereinafter, each of the components that can make up the cathode composite material for a chloride-ion battery according to the present disclosure will be described.

### Cathode Active Material

The cathode composite material for a chloride-ion battery according to the present disclosure includes the cathode active material for a chloride-ion battery according to the present disclosure. For the cathode active material for a chloride-ion battery according to the present disclosure, the above description regarding the cathode active material for a chloride-ion battery according to the present disclosure can be referenced.

The content of the cathode active material in the cathode composite material may be, for example, 1% by mass or more, 5% by mass or more, 10% by mass or more, 15% by mass or more, 20% by mass or more, 25% by mass or more, or 30% by mass or more, and may be 100% by mass or less, 80% by mass or less, 60% by mass or less, 50% by mass or less, 45% by mass or less, 40% by mass or less, 35% by mass or less, or 30% by mass or less. This content may be 10% by mass or more and 50% by mass or less, 15% by mass or more and 45% by mass or less, or 20% by mass or more and 40% by mass or less.

The cathode active material that is contained in the cathode composite material may be the cathode active material according to the present disclosure alone, or may be a combination of the cathode active material according to the present disclosure and some other cathode active material. The cathode active material other than the cathode active material according to the present disclosure is not limited in particular and may be, for example, a metal chloride. The metal chloride is not limited in particular, and may be, for example, a chloride of a poor metal such as bismuth chloride (BiCl₃), gallium chloride (GaCl₃), indium chloride (InCl₃), or the like; a chloride of a noble metal such as copper chloride (CuCl), silver chloride (AgCl), or the like; a chloride of an iron group element such as nickel chloride (NiCl₂), cobalt chloride (CoCl₂), iron chloride (FeCl₂), or the like; and vanadium chloride (VCl₃), and so forth, which are known as cathode active materials for chloride-ion batteries.

The proportion of the cathode active material according to the present disclosure in the total (100% by mass) of the cathode active material that is contained in the cathode composite material may be, for example, 50% by mass or more and 100% by mass or less, 60% by mass or more and 100% by mass or less, 70% by mass or more and 100% by mass or less, 80% by mass or more and 100% by mass or less, 90% by mass or more and 100% by mass or less, 95% by mass or more and 100% by mass or less, 99% by mass or more and 100% by mass or less, or 100% by mass. That is to say, all of the cathode active materials that are contained in the cathode composite material may be the cathode active material according to the present disclosure.

### Solid Electrolyte

The cathode composite material may include a solid electrolyte. The solid electrolyte aids in chloride ion conduction.

The solid electrolyte is not limited in particular, and may be, for example, at least one type that is selected from tin chloride (SnCl₂), strontium chloride (SrCl₂), barium chloride (BaCl₂), and so forth.

The solid electrolyte may be one of the above chlorides that is doped with potassium (K), such as Sr₁₋ₓKₓC₂₋ₓ (0<x≤0.1), for example.

Sr₁₋ₓKₓC₂₋ₓ (0<x≤0.1) can be produced by subjecting a given molar ratio of strontium chloride (SrCl₂) and potassium chloride (KCl) to mechanical impact, for example. An example of such a method is mechanical milling. Specifically, an example of such a method includes mixing the raw materials using a ball mill device. The mode of operation of the ball mill device may be any mode of planetary, vibration, rotational, or other such modes. Using a planetary ball mill device enables samples to be mixed efficiently. This step may be carried out under an inert gas atmosphere.

When the raw materials are mixed using a planetary ball mill device, the table rotation speed is not limited in particular, and may be, for example, 300 rpm or more, 400 rpm or more, 500 rpm or more, or 600 rpm or more, and may be 1000 rpm or less, 900 rpm or less, 800 rpm or less, 700 rpm or less, or 600 rpm or less. The table rotation speed may be 600 rpm.

When the raw materials are mixed using a planetary ball mill device, the mixing time is not limited in particular, and may be 0.5 hours or more, 1 hour or more, 2 hours or more, or 3 hours or more, and may be 10 hours or less, 8 hours or less, 6 hours or less, 4 hours or less, or 3 hours or less. The mixing time may be 3 hours.

The content of the solid electrolyte in the cathode composite material may be, for example, 1% by mass or more, 5% by mass or more, 10% by mass or more, 20% by mass or more, 30% by mass or more, 40% by mass or more, 50% by mass or more, or 60% by mass or more, and may be 99% by mass or less, 95% by mass or less, 90% by mass or less, 80% by mass or less, or 70% by mass or less. This content may be 40% by mass or more and 90% by mass or less, 50% by mass or more and 80% by mass or less, or 60% by mass or more and 70% by mass or less.

The shape, size, and so forth of the solid electrolyte are not limited in particular as long as being capable of functioning as a solid electrolyte in a chloride-ion battery.

### Conductive Aid

The cathode composite material may contain a conductive aid. The conductive aid is not limited in particular as long as it has electronic conductivity.

The conductive aid may be, for example, a carbon material, an elemental metal or a metal compound, or a combination thereof.

The carbon material may be at least one type that is selected from, for example, carbon black such as acetylene black, Ketjen black, furnace black, or the like, graphite powder, fibrous carbon materials such as vapor grown carbon fiber (VGCF) or the like, and so forth.

The content of the conductive aid in the cathode composite material is not limited in particular and may be, for example, 1% by mass or more, 5% by mass or more, or 10% by mass or more, and may be 30% by mass or less, 20% by mass or less, or 10% by mass or less.

### Other Components

The cathode composite material may or may not contain various types of additives other than the various types of components described above. Other components are not limited in particular, and examples thereof include a binder or the like. It is sufficient for the binder to be any binder that is chemically and electrically stable in a chloride-ion battery.

The types, contents, and so forth, of other components can be set as appropriate.

### Production Method of Cathode Composite Material for Chloride-Ion Battery

A production method of a cathode composite material for a chloride-ion battery may include the following steps:
providing a raw material comprising strontium ruthenium oxide, and
applying mechanical impact to the raw material.

An example of a method for applying a mechanical impact to a raw material is mechanical milling. Specifically, an example of such a method includes mixing the raw materials using a ball mill device. The mode of operation of the ball mill device may be any mode of planetary, vibration, rotational, or other such modes. Using a planetary ball mill device enables samples to be mixed efficiently. This step may be carried out under an inert gas atmosphere.

When the raw materials are mixed using a planetary ball mill device, the table rotation speed is not limited in particular, and may be, for example, 1 rpm or more, 10 rpm or more, 50 rpm or more, or 100 rpm or more, and may be 300 rpm or less, 200 rpm or less, 150 rpm or less, or 100 rpm or less. The table rotation speed may be 100 rpm.

When the raw materials are mixed using a planetary ball mill device, the mixing time is not limited in particular, and may be 1 hour or more, 3 hours or more, 5 hours or more, or 10 hours or more, and may be 30 hours or less, 20 hours or less, 15 hours or less, or 10 hours or less. The mixing time may be 10 hours.

For raw materials that can be blended other than strontium ruthenium oxide, the above description regarding the cathode composite material for a chloride-ion battery according to the present disclosure can be referenced.

### Chloride-Ion Battery

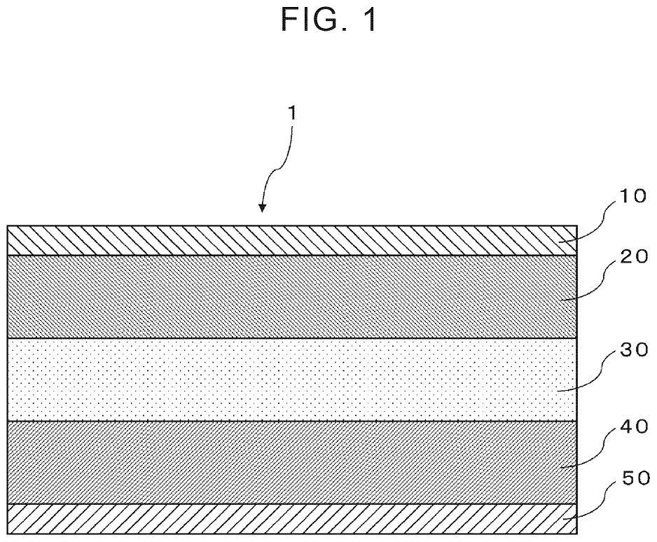

As exemplified in FIG. 1, a chloride-ion battery 1 according to the present disclosure includes a cathode active material layer 20, and also the cathode active material layer contains the cathode composite material for a chloride-ion battery according to the present disclosure. The chloride-ion battery according to the present disclosure have improved cycle characteristics, due to containing the cathode composite material for a chloride-ion battery according to the present disclosure.

As exemplified in FIG. 1, the chloride-ion battery 1 according to the present disclosure may have the cathode active material layer 20, an electrolyte layer 30, and an anode active material layer 40, in that order.

The chloride-ion battery according to the present disclosure may be a liquid battery containing an electrolytic solution as the electrolyte layer, or may be a solid-state battery having a solid electrolyte layer as the electrolyte layer. Note that with respect to the present disclosure, “solid-state battery” refers to a battery that uses at least a solid electrolyte as the electrolyte, and hence, a solid-state battery may use a combination of a solid electrolyte and a liquid electrolyte as the electrolyte. Also, the solid-state battery according to the present disclosure may be an all-solid-state battery, i.e., a battery that uses only a solid electrolyte as the electrolyte.

The chloride-ion battery may be a primary battery or a secondary battery.

The shape of the chloride-ion battery may be, for example, in the form of a coin, a laminate (pouch), or have a cylindrical or a prismatic form.

The chloride-ion battery can be manufactured by forming each of the above layers in a dry manner or a wet manner, or the like.

The chloride-ion battery according to the present disclosure can be suitably used in at least one type of vehicle that is selected from, for example, a hybrid electric vehicle (HEV), a plug-in hybrid electric vehicle (PHEV), and a battery electric vehicle (BEV).

Each of the elements making up the chloride-ion battery according to the present disclosure will be exemplarily described below, with respect to a case in which the chloride-ion battery according to the present disclosure is an all-solid-state battery.

### Cathode Active Material Layer

The cathode active material layer contains the cathode composite material for a chloride-ion battery according to the present disclosure. For the cathode composite material for a chloride-ion battery according to the present disclosure, the above description regarding the cathode composite material for a chloride-ion battery according to the present disclosure can be referenced.

The cathode active material layer may be, for example, a compact of the cathode composite material itself, for a chloride-ion battery according to the present disclosure.

The shape of the cathode active material layer is not limited in particular, and may be, for example, a sheet having a substantially flat face.

The thickness of the cathode active material layer is not limited in particular, and it is sufficient for the thickness thereof to be an appropriate thickness in accordance with the configuration of the chloride-ion battery, or the like. The thickness of the cathode active material layer may be, for example, 100 nm or more and 1 mm or less.

### Electrolyte Layer

The electrolyte layer may be a solid electrolyte layer containing a solid electrolyte. For the solid electrolyte, the above description regarding the cathode composite material for a chloride-ion battery according to the present disclosure can be referenced.

The shape of the electrolyte layer is not limited in particular, and may be, for example, a sheet having a substantially flat face.

The thickness of the electrolyte layer is not limited in particular, and may be an appropriate thickness in accordance with the configuration of the chloride-ion battery, or the like. The thickness of the electrolyte layer may be, for example, 100 nm or more and 1 mm or less.

### Anode Active Material Layer

The anode active material layer contains an anode active material, and may optionally contain a solid electrolyte, a conductive aid, or the like.

The anode active material is not particularly limited as long as potential thereof is lower than that of the cathode active material. Examples of such active materials include elemental metals such as lead (Pb), tin (Sn), and so forth, alloys, oxides thereof, and chlorides thereof.

The anode active material may be, for example, CsSnCl₃, or may be CsSn₁₋ₓYₓCl₃₊ₓ (0<x≤0.1) that is CsSnCl₃ doped with yttrium (Y).

CsSnCl₃ can be produced by subjecting cesium chloride (CsCl) and tin chloride (SnCl₂), of a predetermined molar ratio, to mechanical impact, for example. An example of such a method is mechanical milling. Specifically, an example of such a method includes mixing the raw materials using a ball mill device. The mode of operation of the ball mill device may be any mode of planetary, vibration, rotational, or other such modes. Using a planetary ball mill device enables samples to be mixed efficiently. This step may be carried out under an inert gas atmosphere.

When the raw materials are mixed using a planetary ball mill device, the table rotation speed is not limited in particular, and may be, for example, 300 rpm or more, 400 rpm or more, 500 rpm or more, or 600 rpm or more, and may be 1000 rpm or less, 900 rpm or less, 800 rpm or less, 700 rpm or less, or 600 rpm or less. The table rotation speed may be 600 rpm.

When the raw materials are mixed using a planetary ball mill device, the mixing time is not limited in particular, and may be 1 hour or more, 3 hours or more, 5 hours or more, or 10 hours or more, and may be 30 hours or less, 20 hours or less, 15 hours or less, or 10 hours or less. The mixing time may be 10 hours.

### Solid Electrolyte and Conductive Aid

For the solid electrolyte and the conductive aid, the above description regarding the cathode composite material for a chloride-ion battery according to the present disclosure can be referenced.

The shape of the anode active material layer is not limited in particular, and may be, for example, a sheet having a substantially flat face.

The thickness of the anode active material layer is not limited in particular, and may be an appropriate thickness in accordance with the configuration of the chloride-ion battery, or the like. The thickness of the anode active material layer may be, for example, 100 nm or more and 1 mm or less.

### Other Configurations

The chloride-ion battery according to the present disclosure may further include a cathode current collector layer 10 and an anode current collector layer 50, as illustrated in FIG. 1. There are no particular limitations on the materials, shapes, thicknesses, and so forth, of the cathode current collector layer and the anode current collector layer, as long as they can function as current collector layers for a chloride-ion battery. Also, the chloride-ion battery according to the present disclosure may further have other configurations.

### Example 1

### Synthesis of Cathode Active Material for Chloride-ion Battery

### Raw Material Mixing Step

Strontium carbonate (SrCO₃) and ruthenium oxide (RuO₂) were weighed out so as to have a molar composition of 3:2, and mixed in a mortar to obtain a raw material mixture.

### First Pellet Forming Step

The raw material mixture thus obtained was pelletized by an ordinary method in solid-phase synthesis to form first pellets.

### First Firing Step

The first pellets thus obtained were fired in an electric furnace at 1350° C. for 20 hours.

### Crushing Step

The first pellets that were fired were crushed by an ordinary method to obtain crushed material.

### Crushed Material Mixing Step

The crushed material thus obtained was mixed in a mortar to obtain a crushed material mixture.

### Second Pellet Forming Step

The crushed material mixture thus obtained was pelletized by an ordinary method in solid-phase synthesis to form second pellets.

### Second Firing Step

The second pellets thus obtained were fired in an electric furnace at 1350° C. for 20 hours. Thus, a cathode active material for a chloride-ion battery, which is strontium ruthenium oxide (Sr₃Ru₂O₇) having a layered perovskite structure, was obtained.

### Fabrication of Chloride-ion Battery

Sr₃Ru₂O₇ serving as a cathode active material, SrCl₂ (Sr_{0.97}K_{0.03}Cl_{1.97}) that was doped with potassium (K) serving as a solid electrolyte, and vapor grown carbon fiber (VGCF) (manufactured by Showa Denko K.K.) serving as a conductive aid, were weighed out to a mass ratio of 30:60:10. The above raw materials were mixed for 10 hours at 100 rpm using a ball mill, thereby obtaining a cathode composite material for a chloride-ion battery. This was subjected to powder compaction to form a cathode active material layer.

The Sr_{0.97}K_{0.03}Cl_{1.97} serving as the solid electrolyte was synthesized by mechanical milling of strontium chloride (SrCl₂) and potassium chloride (KCl) using a ball mill at 600 rpm for 3 hours.

The solid electrolyte layer was formed by powder compaction of the Sr_{0.97}K_{0.03}Cl_{1.97} serving as the solid electrolyte.

The anode active material layer was formed by placing Sn foil on one side of a layer that was formed using CsSnCl₃ (the side on which the anode current collector layer is to be disposed later). The CsSnCl₃ was synthesized by weighing out cesium chloride (CsCl) and tin chloride (SnCl₂) in a predetermined molar ratio and mechanically milling the mixture using a ball mill at 600 rpm for 10 hours.

The cathode current collector layer, the cathode active material layer, the solid electrolyte layer, the anode active material layer, and the anode current collector layer, were laminated in this order to fabricate the all-solid-state chloride-ion battery.

### Evaluation

### X-Ray Diffraction (XRD) Measurement

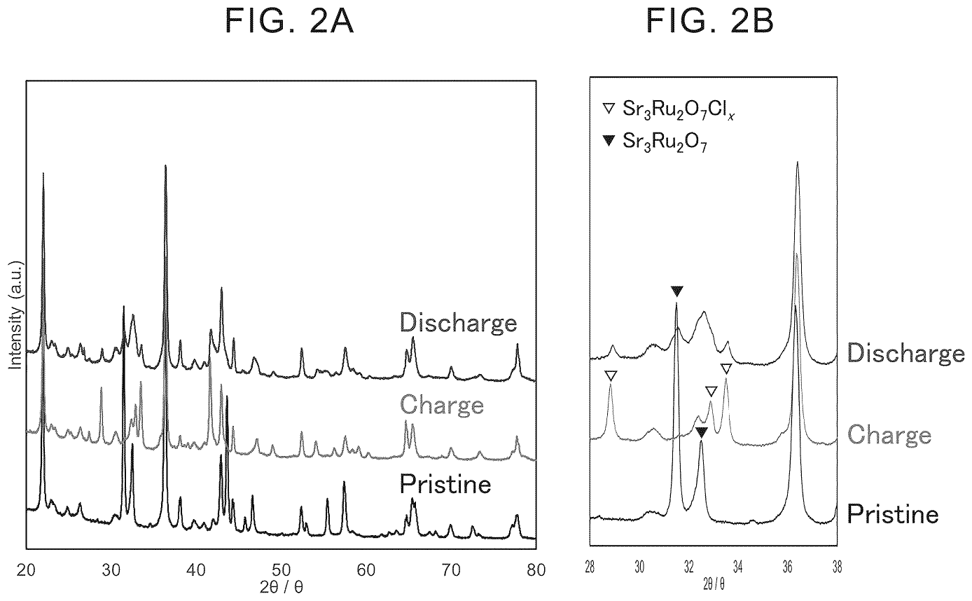

A sample of the cathode active material layer that was formed from the cathode composite material was subjected to XRD measurement in a pristine state before the battery was operated, in a charged state, and in a discharged state. The XRD measurement was performed by a focusing method with irradiation by CuKα rays, using an Ultima IV manufactured by Rigaku Corporation as an X-ray diffraction device, under an inert gas atmosphere, under conditions of a tube voltage of 40 kV and a tube current of 40 mA. The sample was sealed in an airtight sample stage in an argon atmosphere, and was measured without exposure to the ambient atmosphere. A glass sample holder was used as a substrate for mounting the sample. XRD patterns that were obtained are shown in FIGS. 2A and 2B. FIG. 2A is an XRD pattern of the battery according to Example 1, and FIG. 2B is an enlarged view of a region from 8° to 38° in the XRD pattern in FIG. 2A.

As shown in FIGS. 2A and 2B, and particularly in FIG. 2B, in the battery according to Example 1, it was confirmed that Sr₃Ru₂O₇ was produced in the pristine state. It was also confirmed that in the charged state, Sr₃Ru₂O₇Clₓ was produced, i.e., the layered perovskite structure of the Sr₃Ru₂O₇ was maintained. This suggests that in a battery including the cathode active material for a chloride-ion battery according to the present disclosure, and charging/discharging is carried out by intercalation reaction.

### Charging/Discharging Test

The chloride-ion battery according to the Example was charged and discharged 10 times at a testing temperature of 140° C. and a current density of 0.03 mA/cm² while evacuated in a sealed container. Constant-voltage charging was performed with a lower limit current of 0.001 mA/cm², in which charging termination conditions were an upper limit voltage of 1.4 V. The discharging termination conditions were a lower limit voltage of −1.0V. An electrochemical measurement system equipped with a frequency response analyzer (VMP-300 high-performance electrochemical measurement system, manufactured by Bio-Logic Corporation) was used for the charging/discharging test.

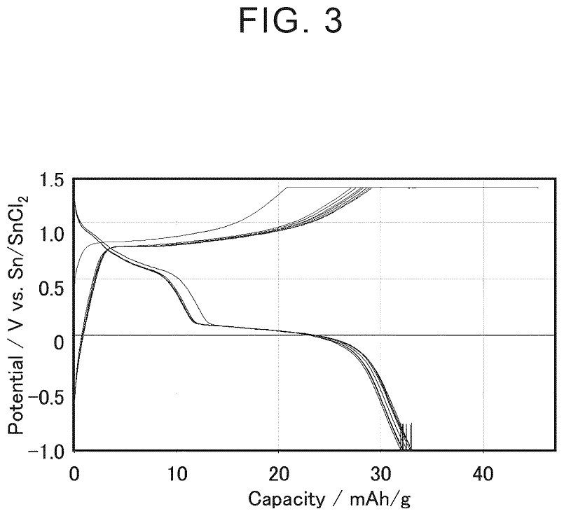

The charging/discharging curves of the battery according to Example 1 are shown in FIG. 3. Also, Table 1 shows initial discharge capacity, discharge capacity at the 10th cycle, and capacity retention rate. Note that “capacity retention rate” means the discharge capacity at 10th cycle/initial discharge capacity.

### Comparative Example 1

### Fabrication of Chloride-Ion Battery

An all-solid-state chloride-ion battery was fabricated in the same manner as in Example 1, except that bismuth chloride (BiCl₃) was used as the cathode active material.

### Evaluation

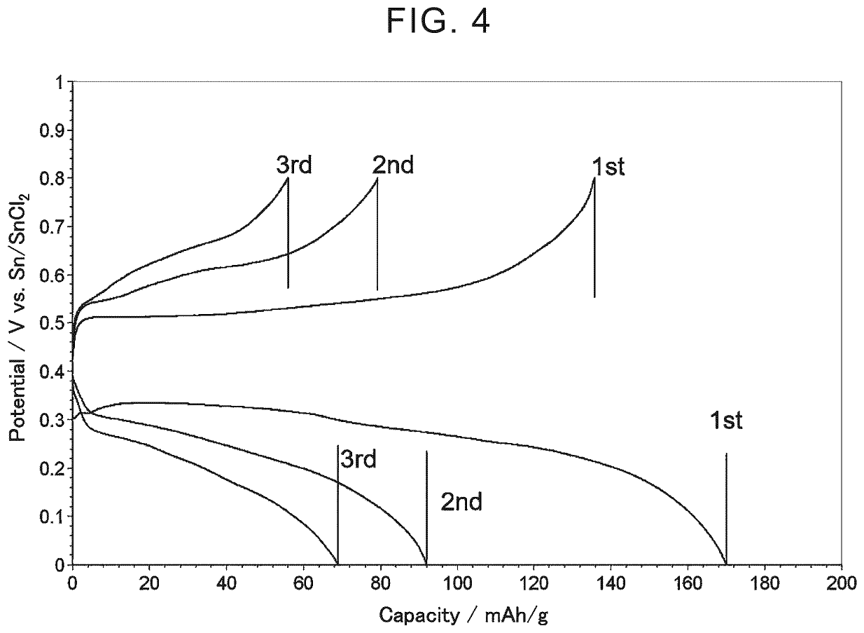

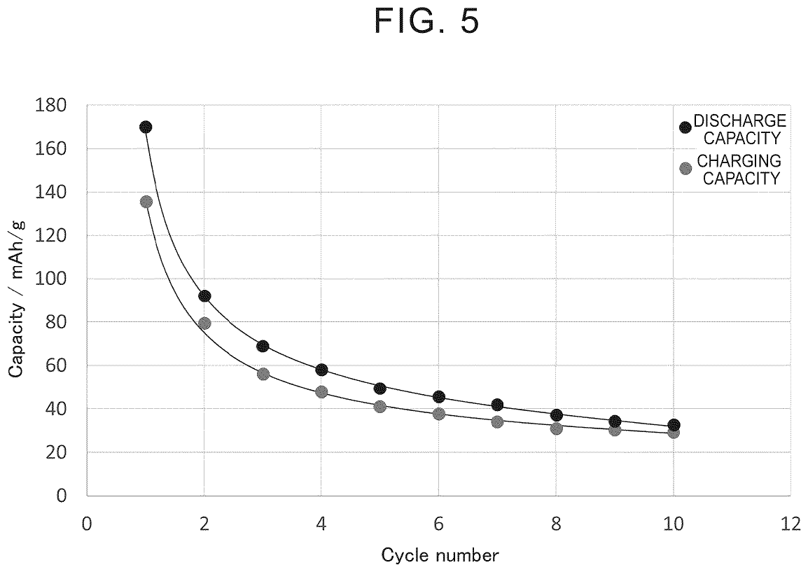

Evaluation was carried out in the same manner as in Example 1 except that the charge termination conditions were an upper limit voltage of 0.8 V, constant voltage charging was not performed, and discharging termination conditions were a lower limit voltage of 0 V. The discharge curves of the battery according to Comparative Example 1 are shown in FIG. 4, and the cycle characteristics, i.e., relation between the number of charging/discharging cycles and capacity, is shown in FIG. 5.

TABLE 1

| | Initial discharge | Discharge capacity | Capacity |
|---|---|---|---|
| | capacity | at 10th cycle | retention rate |
| | [mAh/g] | [mAh/g] | [%] |
| Example 1 | 33.1 | 32 | 96.7 |
| Comparative | 170 | 33.5 | 19.7 |
| Example 1 | | | |

As shown in FIG. 3 and Table 1, the battery according to the Example containing strontium ruthenium oxide having a layered perovskite structure as the cathode active material had a high capacity retention rate, and the capacity was hardly reduced after cycles of charging/discharging. In contrast, as shown in FIGS. 4 and 5 and Table 1, the capacity retention rate of the battery according to the Comparative Example decreased significantly.

What is claimed is:

1. A cathode active material for a chloride-ion battery, wherein the cathode active material is a strontium ruthenium oxide with a layered perovskite structure.

2. The cathode active material according to claim 1, wherein the strontium ruthenium oxide is Sr₃Ru₂Oₓ (5≤x≤7).

3. A cathode composite material for a chloride-ion battery, the cathode composite material comprising the cathode active material according to claim 1.

4. A chloride-ion battery comprising a cathode active material layer, wherein the cathode active material layer contains the cathode composite material according to claim 3.

5. A production method for producing the cathode active material according to claim 1, the production method comprising:
(a) preparing a raw material mixture by mixing strontium carbonate and ruthenium oxide;
(b) pelletizing the raw material mixture into pellets; and
(c) firing the pellets.
